(19) United States
(12) Patent Application Publication
(10) Pub. No.: US 2026/0116355 A1
(43) Pub. Date: Apr. 30, 2026

(54) FOLDABLE PARTITION APPARATUS FOR VEHICLE

(71) Applicants: HYUNDAI MOTOR COMPANY, Seoul (KR); KIA CORPORATION, Seoul (KR)

(72) Inventors: Eun Sik KIM, Hwaseong-si (KR); Jung Hoon WOO, Hwaseong-si (KR)

(21) Appl. No.: 19/197,379

(22) Filed: May 2, 2025

(30) Foreign Application Priority Data
Oct. 24, 2024 (KR) 10-2024-0146690

(51) Int. Cl. B60T 7/06; G05G 1/44; G05G 5/00

(52) U.S. Cl. CPC B60T 7/06; G05G 1/44; G05G 5/005; G05G 2505/00

(57) ABSTRACT

A foldable partition apparatus is configured to interact with a foldable pedal in an autonomous vehicle. The foldable partition apparatus includes a side cover rotatably disposed at a side of a foldable pedal module of the vehicle, and an actuator configured to rotate the side cover based on the foldable pedal module being folded and unfolded. The foldable partition apparatus is provided at a center of an autonomous vehicle to remove a center console and partitions a driver's seat and a passenger seat, thereby reducing the manufacturing costs of the vehicle.

### CROSS-REFERENCE TO RELATED APPLICATIONS

The present application claims priority to Korean Patent Application No. 10-2024-0146690, filed on Oct. 24, 2024, the entire contents of which are incorporated herein for all purposes by this reference.

### TECHNICAL FIELD

The present disclosure relates to a foldable partition apparatus that interacts with a foldable pedal used in an autonomous vehicle.

### BACKGROUND

An autonomous vehicle may include a smart vehicle having an autonomous driving technology that enables the vehicle to travel to a destination although a driver does not manually operate a steering wheel, an accelerator pedal, and a brake.

In some cases of autonomous driving, a driver may select a manual driving mode, in which the driver directly operates a vehicle, or an autonomous driving mode, in which a vehicle independently drives to the destination without an operation of the driver.

When the driver selects the autonomous driving mode, the driver may extend his legs to take a rest. For instance, when pedals (accelerator pedal and brake pedal) disposed in a lower space of a driver's seat are exposed in the autonomous driving mode, the pedals may interrupt the rest of the driver. In some cases, when the driver accidently presses the pedals regardless of intention of the driver, the autonomous driving may be terminated, and a risk of accidents may increase.

In some cases, the autonomous vehicles may include a foldable pedal device that allows pads of the pedal devices to be exposed and to protrude toward the driver so that the driver operates the pads in the manual driving mode, where the foldable pedal device may allow the pads to be hidden instead of protruding toward the driver so that the driver may not operate the pads for comfortable rest of the driver and for safety such as malfunction prevention in the autonomous driving mode.

In some cases of the vehicle including the foldable pedal device, while the driver operates the vehicle by pressing the accelerator pedal in manual driving mode, the driver may not fully press the accelerator pedal. Thus, a portion of the foldable pedal device may support foots of the driver.

In some cases, a vehicle may include a side wall that is disposed next to the accelerator pedal and that provides support for the foot pressing the accelerator pedal. In some cases, autonomous vehicles may not have a center console for improving space usage. The autonomous vehicles may not include a portion to support the foot pressing the accelerator pedal during driving, which may cause the driver to experience fatigue in his legs.

In some cases, an autonomous vehicle may not include a device to partition a passenger seat from a driver's seat in the manual driving mode, where a passenger in the passenger seat may accidentally extend a foot and press the accelerator pedal.

### SUMMARY

The present disclosure describes a foldable partition apparatus for a foldable pedal that can help prevent a pedal malfunction of a passenger on a passenger seat and that can support a foot by forming a partition as a side cover part is unfolded at a side of an accelerator pedal when the folded accelerator pedal and brake pedal are unfolded by a manual driving mode.

According to one aspect of the subject matter described in this application, a foldable partition apparatus for a vehicle includes a side cover rotatably disposed at a side of a foldable pedal module of the vehicle, and an actuator configured to rotate the side cover based on the foldable pedal module being folded and unfolded.

Implementations according to this aspect can include one or more of the following features. For example, the side cover can include a first cover part that defines an inner accommodation space therein and is configured to protrude outward relative to the foldable pedal module, the first cover part having a first end that is rotatably coupled to the vehicle, and a second cover part that is disposed in the inner accommodation space of the first cover part and has an end that is rotatably coupled to the vehicle, the second cover part being configured to (i) protrude outward from the inner accommodation space based on the first cover part rotating about the first end of the first cover part and (ii) protrude outward relative to the foldable pedal module based on the second cover part rotating together with the first cover part.

In some implementations, the actuator can be connected to the first cover part and configured to rotate the first cover part about the first end of the first cover part. In some examples, the actuator can include a rod that extends in an axial direction, where the first cover part can include a first cover that includes a first side wall including an actuator coupling part coupled to the actuator in the axial direction, the actuator coupling part defining a rod hole coupled to the rod of the actuator, a first peripheral wall disposed at an edge of the first side wall, and a second side wall that has a fan shape, where an edge of the second side wall is coupled to the first peripheral wall.

In some implementations, the first peripheral wall can include a first linear part that linearly extends between ends of the first side wall, a first arc part that is connected to the first linear part and extends along an arc edge of the first side wall, and a first peripheral part that is spaced apart from the actuator coupling part and surrounds the actuator coupling part. In some examples, the first arc part can have (i) a first end portion connected to the first linear part and (ii) a second end portion disposed away from the first linear part, where the first arc part can include a first stopper that protrudes inward from an inner surface of the first arc part and is disposed at the second end portion of the first arc part.

In some implementations, the first peripheral part can include a folding stopper that protrudes outward from an outer surface of the first peripheral part, the folding stopper being configured to contact a bottom surface of a footrest panel of the foldable pedal module based on the side cover being in a folded state. In some examples, the second cover part can include a pair of third side walls that have a fan shape and face each other, where a size of each of the pair of third side walls is less than a size of the first side wall, and the pair of third side walls define insertion holes that receive the actuator coupling part, and a second peripheral wall disposed at edges of the pair of third side walls.

In some examples, the second peripheral wall can include a second linear part that linearly extend between ends of the pair of third side walls, and a second arc part that is connected to the second linear part and extends along an arc edge of the pair of third side walls. In some examples, the second arc part has an end portion connected to the second linear part, where the second arc part can include a second stopper that is disposed at the end portion of the second arc part and protrudes outward from an outer surface of the second arc part, the second stopper being configured to interfere with the first stopper.

According to another aspect, a vehicle includes a foldable pedal module comprising (i) a footrest panel and (ii) a brake pedal or an accelerator pedal, the foldable pedal module being configured to be folded and unfolded relative to the footrest panel, and a side cover disposed at a side of the foldable pedal module and configured to protrude outward relative to the footrest panel based on the foldable pedal module being unfolded. The foldable pedal module further includes an actuator configured to fold and unfold (i) the brake pedal or the accelerator pedal and (ii) the side cover.

Implementations according to this aspect can include one or more of the following features and the features described above. For example, the side cover can include a first cover part that defines an inner accommodation space therein and is configured to protrude outward relative to the foldable pedal module, the first cover part having a first end rotatably coupled to the footrest panel, and a second cover part that is disposed in the inner accommodation space of the first cover part and has an end that is rotatably coupled to the vehicle, the second cover part being configured to (i) protrude outward from the inner accommodation space based on the first cover part rotating about the first end of the first cover part and (ii) protrude outward relative to the foldable pedal module based on the second cover part rotating together with the first cover part.

In some implementations, the actuator can include a motor comprising a rotating shaft, a first gear disposed at the rotating shaft, a second gear engaged with the first gear, a link bar connected to a center of the second gear and configured to rotate based on rotation of the second gear, a support member connected to the link bar, the support member comprising a driven rotor configured to reciprocally move based on rotation of the link bar, a pedal effort generation module that includes a cam profile and is configured to fold and unfold the brake pedal or the accelerator pedal based on a reciprocal movement of the driven rotor, a third gear disposed at an axis of the second gear and configured to rotate based on rotation of the second gear, and a fourth gear connected to the first cover part and engaged with the third gear.

In some implementations, the actuator can further include a rod that extends in an axial direction, where the first cover part can include a first cover that includes a first side wall including an actuator coupling part coupled to the actuator in the axial direction, the actuator coupling part defining a rod hole coupled to the rod of the actuator, a first peripheral wall disposed at an edge of the first side wall, and a second side wall that has a fan shape, where an edge of the second side wall is coupled to the first peripheral wall.

In some implementations, the first peripheral wall can include a first linear part that linearly extends between ends of the first side wall, a first arc part that is connected to the first linear part and extends along an arc edge of the first side wall, and a first peripheral part that is spaced apart from the actuator coupling part and surrounds the actuator coupling part. In some examples, the first arc part can have (i) a first end portion connected to the first linear part and (ii) a second end portion disposed away from the first linear part, where the first arc part can include a first stopper that protrudes inward from an inner surface of the first arc part and is disposed at the second end portion of the first arc part.

In some implementations, the first peripheral part can include a folding stopper that protrudes outward from an outer surface of the first peripheral part, the folding stopper being configured to contact a bottom surface of the footrest panel based on the side cover being in a folded state. In some implementations, the second cover part can include a pair of third side walls that have a fan shape and face each other, where a size of each of the pair of third side walls is less than a size of the first side wall, and the pair of third side walls define insertion holes that receive the actuator coupling part, and a second peripheral wall disposed at edges of the pair of third side walls.

In some implementations, the second peripheral wall can include a second linear part that linearly extend between ends of the pair of third side walls, and a second arc part that is connected to the second linear part and extends along an arc edge of the pair of third side walls. In some examples, the second arc part has an end portion connected to the second linear part, where the second arc part can include a second stopper that is disposed at the end portion of the second arc part and protrudes outward from an outer surface of the second arc part, the second stopper being configured to interfere with the first stopper.

### BRIEF DESCRIPTION OF THE DRAWINGS

FIG. 1 is a view illustrating an example of a folded state of a foldable partition apparatus for a foldable pedal.

FIG. 2 is a view illustrating an unfolded state of the foldable partition apparatus.

FIG. 3 is a side view illustrating the unfolded state of the foldable partition apparatus.

FIG. 4 is a side view illustrating the folded state of the foldable partition apparatus.

FIG. 5 is a view illustrating an example of a first cover of a first cover part of the foldable partition apparatus.

FIG. 6 is a view illustrating an example of a second cover part.

FIG. 7 is a view illustrating a disassembled state of a side cover and an actuator of the foldable partition apparatus.

FIG. 8 is a view illustrating the folded state of the foldable partition apparatus and a state in which the second cover part is accommodated in the first cover part.

FIG. 9 is a view illustrating a state in which the second cover part protrude from the first cover part in the foldable partition apparatus.

FIG. 10 is a view illustrating the unfolded state of the foldable partition apparatus for a foldable pedal.

FIGS. 11 and 12 are views illustrating an example process of unfolding a brake pedal and an accelerator pedal and rotating a second shaft on which a side cover is installed by an actuator in a foldable partition apparatus.

FIG. 13 is a view illustrating a vehicle which an example of a foldable partition apparatus is applied to.

### DETAILED DESCRIPTION

Hereinafter, one or more example implementations disclosed in this specification is described with reference to the accompanying drawings, and the same or corresponding components are given with the same drawing number regardless of reference number, and duplicated descriptions thereof will be omitted.

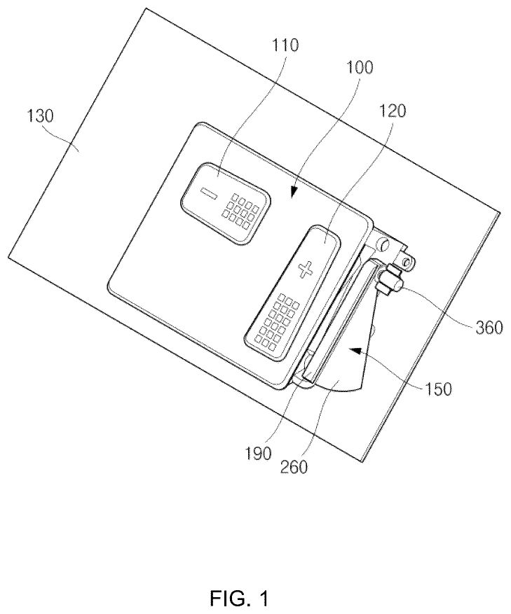

In an autonomous driving mode, as illustrated in FIG. 1, a foldable partition apparatus for foldable pedal is folded when a brake pedal 110 and an accelerator pedal 120 are folded on a footrest panel 130.

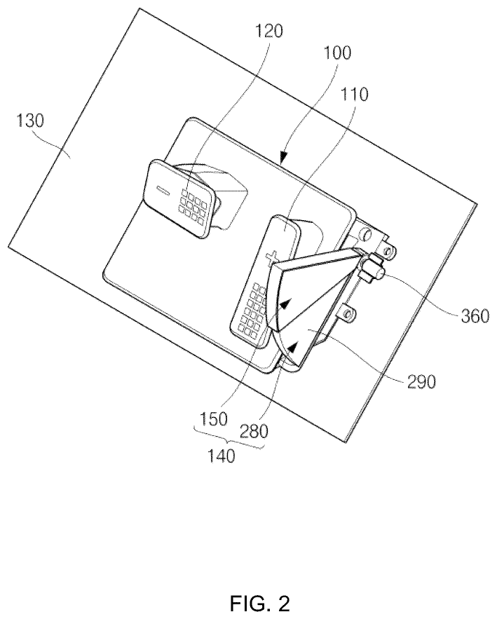

In a manual driving mode, as illustrated in FIG. 2, the brake pedal 110 and the accelerator pedal 120 are unfolded on the footrest panel 130.

Referring to FIGS. 1 and 2, the foldable partition apparatus for foldable pedal is disposed at a right side of the accelerator pedal, which is one side of a foldable pedal module 100.

In some examples, where the accelerator pedal is provided to be pressed continuously during driving, the foldable partition apparatus for foldable pedal can be provided at the right side of the accelerator pedal so that a foot pressing the accelerator pedal is supported by a unfolded side cover 140.

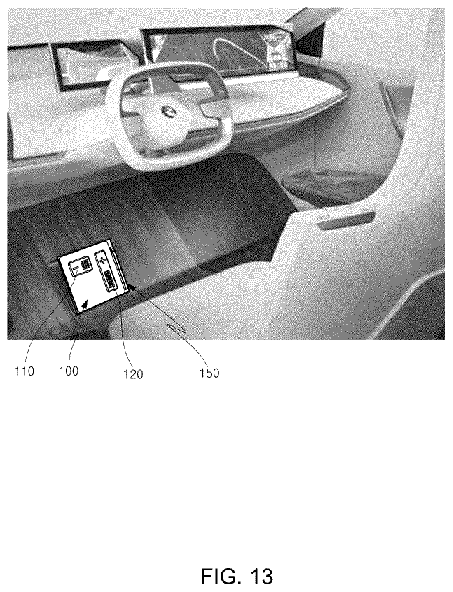

The foldable partition apparatus for foldable pedal can be installed in a vehicle in which a driver's seat is disposed at a left side, as showing in FIG. 13.

The foldable partition apparatus for foldable pedal includes a side cover 140 and an actuator 360.

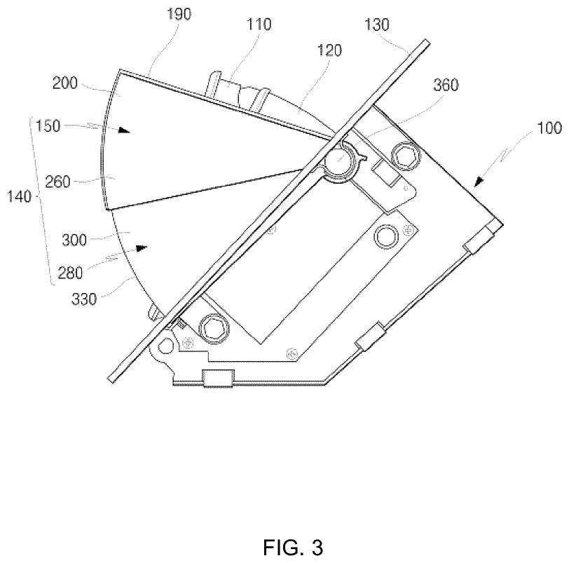

As illustrated in FIG. 3, the side cover 140 is disposed at one side of the foldable pedal module 100 and protrudes to the outside when the brake pedal 110 and the accelerator pedal 120 are unfolded.

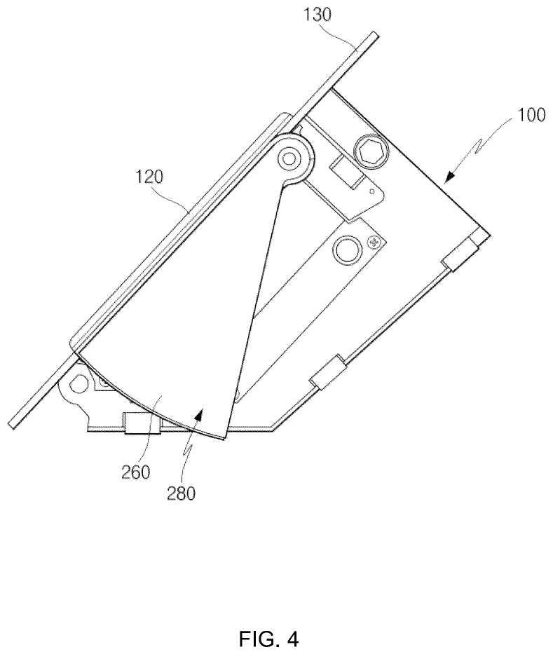

In some examples, when the brake pedal 110 and the accelerator pedal 120 are folded, the side cover 140 is folded to a side surface of the foldable pedal module 100 as illustrated in FIG. 4.

Thus, when the brake pedal 110 and the accelerator pedal 120 are folded, the side cover 140 is folded by the actuator 360 and is not exposed from the footrest panel 130.

The side cover 140 includes a first cover part 150 and a second cover part 280.

As illustrated in FIGS. 3 and 4, the first cover part 150 has one end that is rotatably fixed, has an inner accommodation space, and protrudes to the outside of the foldable pedal module 100 that rotates around one end.

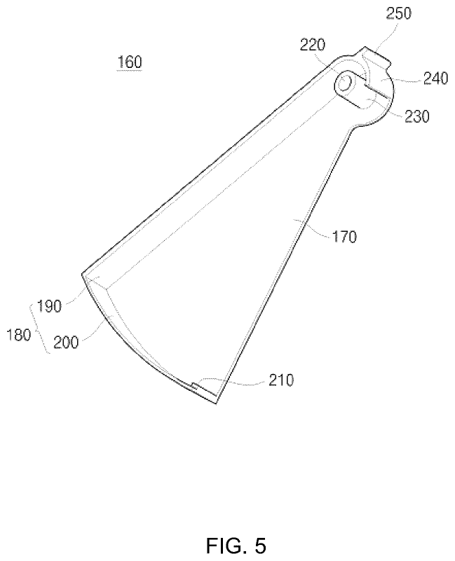

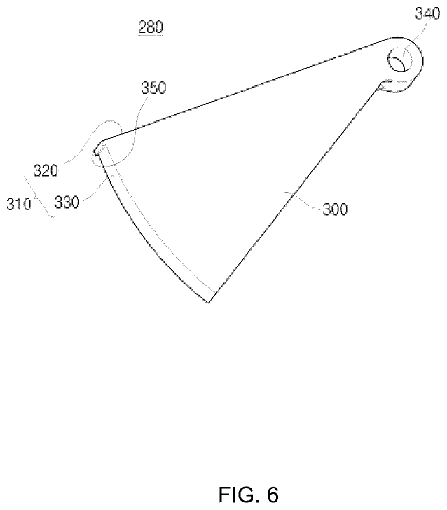

Referring to FIG. 5, the first cover part 150 includes a first cover 160 and a second side wall 260.

The first cover 160 includes a first side wall 170 and a first peripheral wall 180.

The first side wall 170 has a fan shape and includes an actuator coupling part 230 disposed at a central portion of the fan shape and having a rod hole 220 to which a rod part 370 is axially coupled.

The first peripheral wall 180 is formed on at least a portion of an edge of the first side wall 170.

The first peripheral wall 180 includes a first linear part 190 extending linearly from one end to the other end of the first side wall 170.

The first peripheral wall 180 also includes a first arc part 200 having one end connected to the linear part and disposed on an arc of the bottom surface.

The first arc part 200 includes a first stopper 210 protruding from an inner surface of a portion opposite to a portion at which the first arc part 200 is connected to the linear part to the one end.

The first peripheral wall 180 also includes a first peripheral part 240 that surrounds the actuator coupling part 230 while being spaced a predetermined distance therefrom.

As illustrated in FIG. 4, the first peripheral part 240 further includes a folding stopper 250 protruding from an outer surface and brought into contact with a bottom surface of the footrest in a folded state.

The first linear part 190, the first arc part 200, the first peripheral part 240, and first side wall 170, which are described above, are integrated with each other through injection molding.

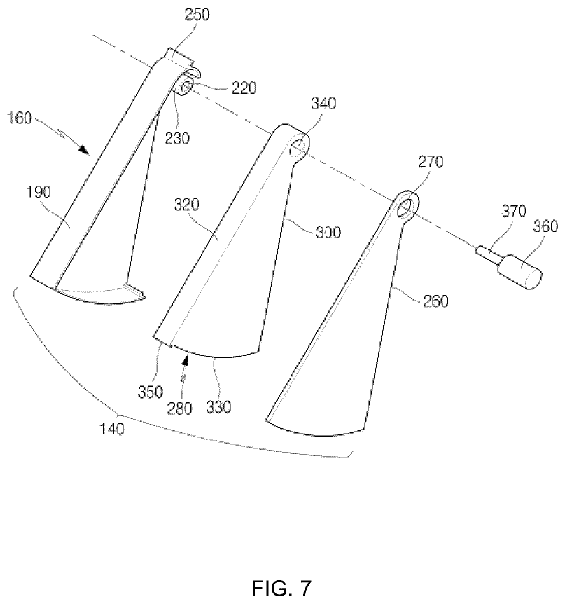

As illustrated in FIG. 7, the second side wall 260 has a fan shape and includes a through-hole 270 axially passing through one end thereof and an edge bonded to at least a portion of the first peripheral wall 180.

The second side wall 260 have the same shape as the first side wall 170 and includes the through-hole 270 having an inner diameter equal to a diameter of the actuator coupling part 230 at a central portion, which is the one end, of the fan shape.

The second cover part 280 has one end that is rotatably fixed and disposed in an accommodating space.

When the first cover part 150 rotates around one end thereof, the second cover part 280 protrudes from the accommodating space. When the second cover part 280 protrudes completely from the accommodating space, the second cover part 280 rotates together by rotation of the first cover part 150 to protruding to the outside of the foldable pedal.

The second cover part 280 includes a third side wall 300 and a second peripheral wall 310.

The third side wall 300 has a shape of a pair of fans, has a size smaller than that of the first side wall 170, and includes an insertion hole 340 formed at one end, to which the actuator coupling part 230 is inserted.

The pair of third side walls 300 are spaced by a thickness of the first peripheral wall 180 from each other. Through this, a hollow space is formed in the second cover part 280 to have an effect of reducing a weight of the second cover part 280.

The second peripheral wall 310 includes a second linear part 320 and a second arc part 330.

The second linear part 320 extends linearly from one end to the other end of the third side wall 300.

The second arc part 330 has one end connected to the second linear part 320 and is formed on an arc of the bottom surface.

The second arc part 330 includes a second stopper 350 that protrudes from an outer surface of a portion in which the second arc part 330 is connected to the second linear part 320 and interacts with the first stopper 210.

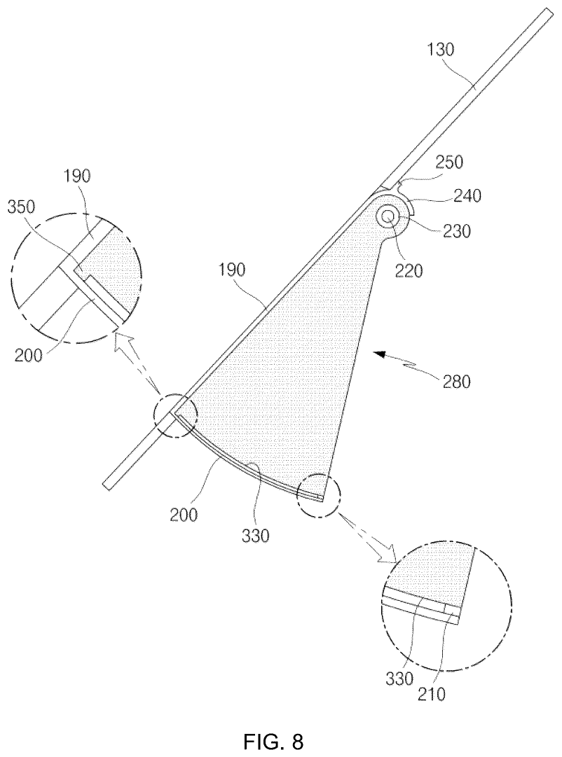

As illustrated in FIGS. 7 and 8, the second cover part 280 is accommodated in the first cover part 150. In some examples, the second side wall 260 is coupled and assembled to the first cover 160.

Referring to FIG. 8, when the second cover part 280 accommodated in the first cover part 150 rotates by the actuator 360, the first stopper 210 moves in a circumferential direction.

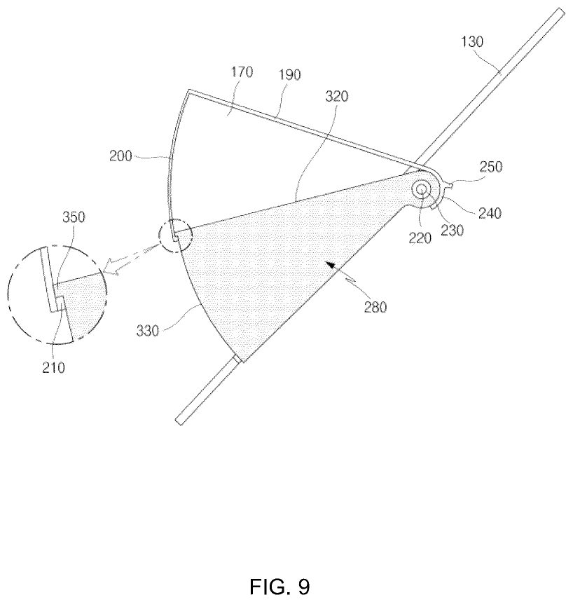

As illustrated in FIG. 9, when the first stopper 210 moves in the circumferential direction and is caught by the second stopper 350 formed on the second cover part 280, while the second cover part 280 rotates together with the first cover part 150, the first cover part 150 and the second cover part 280 are unfolded and exposed to the outside from the footrest panel 130.

An embodiment in which the side cover 140 includes the first cover part 150 and the second cover part 280 is described above.

However, depending on embodiments, the first cover part 150 and the second cover part 280 can be integrated into one part having the same shape as the unfolded state to be folded or unfolded as a single cover part.

The actuator 360 provides power that allows the side cover 140 to rotate.

Specifically, the actuator 360 is connected to one end of the first cover part 150 and supplies power that allows the first cover part 150 to rotate around one end thereof.

In this embodiment, the actuator 360 can be an actuator that provides rotational power and includes a rod part 370. The rod part 370 is fitted into the rod hole 220.

In the above-described embodiment, the actuator 360 that folds or unfolds the brake pedal 110 and the accelerator pedal 120 is separately provided, and the actuator 360 that drives the first cover part 150 is separately provided.

In an embodiment to be described below, a power transmission structure of the actuator 360 in which the first cover part 150 and the second cover part 280 are unfolded together when the brake pedal 110 and the accelerator pedal 120 are unfolded.

A foldable partition apparatus for a foldable pedal according to another embodiment includes a pedal actuator disposed on a side cover 140 and a foldable pedal module 100. Since the side cover 140 is the same as the side cover 140 described above, a detailed description thereof will be omitted.

The actuator 360 includes a first motor 380, a second motor 390, a first gear 400, a second gear 410, a link bar 440, a support part 450, a pedal effort generation module, a third gear 420, and a fourth gear 430.

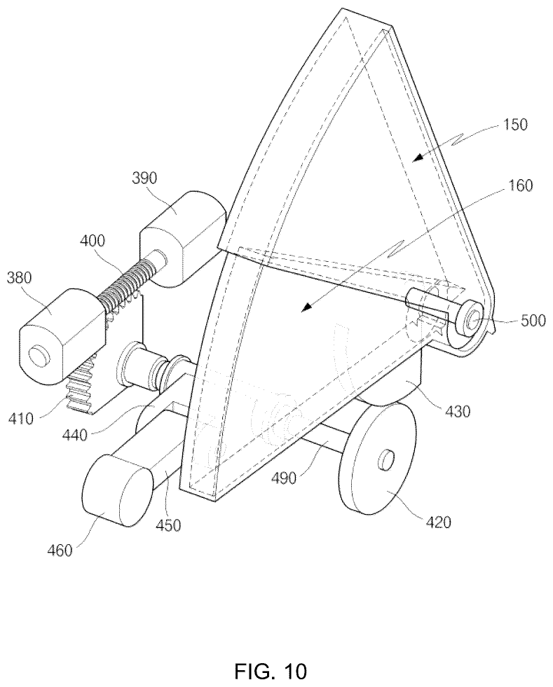

The first motor 380 includes a first rotation shaft. The second motor 390 includes a second rotation shaft. The first motor 380 and the second motor 390 are arranged so that the first rotation shaft of the first motor 380 and the second rotation shaft of the second motor 390 face each other as illustrated in FIG. 10.

The first gear 400 has one side in an axial direction, which is coupled to the first rotation shaft, and the other side in the axial direction, which is coupled to the second rotation shaft.

The first motor 380 and the second motor 390 rotate the first rotation shaft and the second rotation shaft in opposite directions to rotate the first gear 400. The first gear 400 includes a worm.

The second gear 410 is engaged with the first gear 400. The second gear 410 is engaged with the worm. The second gear 410 is a worm wheel having a fan shape and including a gear formed on a circumferential surface thereof.

The link bar 440 has one end connected to a central axis of the second gear 410 and rotates in accordance with rotation of the second gear 410. The link bar 440 is connected to the second gear 410 and a third gear 420 that will be described later through a first shaft 490.

The support part 450 has one end connected to the other end of the link bar 440 and the other end at which a driven rotor 460 is formed and which repeatedly moves the driven rotor 460 in accordance with rotation of the link bar 440.

A pedal effort generation module 470 forms a cam profile 480 that folds or unfolds the brake pedal 110 and the accelerator pedal by the repeated movement of the driven rotor 460.

The third gear 420 is disposed on the same axis as the second gear 410 and rotates in accordance with rotation of the second gear 410. The third gear 420 is a circular gear. In some examples, a bevel gear can be used instead of the circular gear.

The fourth gear 430 is connected to one end of the first cover part 150 and engaged with the third gear 420 to rotate around one end of the first cover part 150.

The fourth gear 430 is a spur gear having a fan shape and formed on a circumferential surface thereof. The fourth gear 430 is coaxially coupled to the rod hole 220 through the second shaft 500.

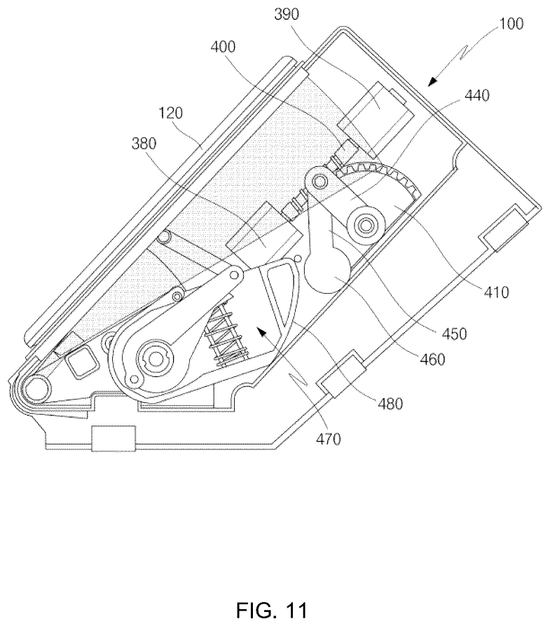

When the brake pedal 110 and the accelerator pedal 120 are folded as illustrated in FIG. 11, the driven rotor 460 is not in contact with the cam profile 480 disposed on the pedal effort generation module 470, and the side cover 140 is also folded.

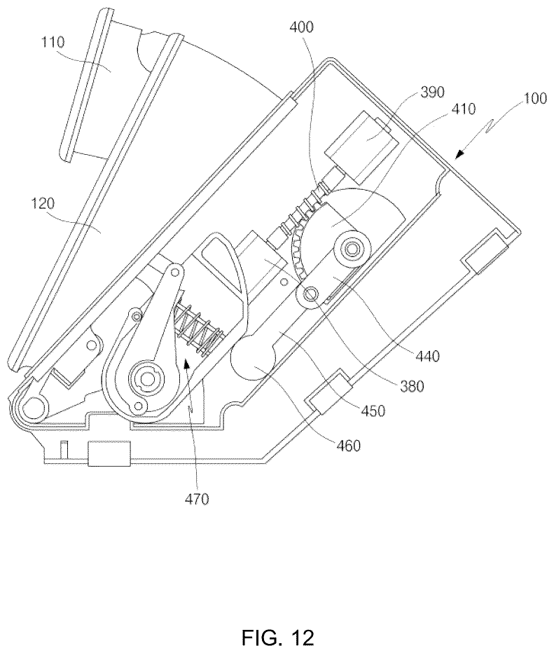

When the first motor 380 and the second motor 390 rotate, the first gear 400 rotates, and the second gear 410 engaged with the first gear 400 rotates to allow the link part to rotate. In some examples, while the support part 450 connected to an end of the link part moves the driven rotor 460 in the axial direction of the first motor 380 or the second motor 390, the driven rotor moves along a surface of the cam profile 480 and unfolds the brake pedal 110 and the accelerator pedal 120 when the driven rotor 460 is disposed below the pedal effort generation module as illustrated in FIG. 12.

Since the first cover part 150 is connected to one end of the link bar 440 through the first shaft 490 at the rod hole 220, when the link bar 440 rotates, the first cover part 150 rotates and is unfolded like the second cover part 280, thereby being exposed upward from the footrest panel 130 as illustrated in FIG. 10.

The present disclosure provides the foldable partition apparatus in the autonomous vehicle to remove the center console that distinguish the driver's seat and the passenger seat at the center, thereby reducing the manufacturing costs of the vehicle.

In some examples, since the partition is unfolded in the manual driving mode, the partition can support the foot while operating the accelerator pedal to reduce the fatigue sense of the driver during manual driving.

In some examples, when a passenger is seated in the passenger seat, the present disclosure can prevent the passenger from accidentally operating the accelerator pedal or brake pedal in the manual driving mode.

The effects to be solved by the present disclosure are not limited to the aforementioned effects and unmentioned effects will be clearly understood by those skilled in the art to which the present disclosure belongs.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A foldable partition apparatus for a vehicle, comprising:
a side cover rotatably disposed at a side of a foldable pedal module of the vehicle; and
an actuator configured to rotate the side cover based on the foldable pedal module being folded and unfolded.

2. The foldable partition apparatus of claim 1, wherein the side cover comprises:
a first cover part that defines an inner accommodation space therein and is configured to protrude outward relative to the foldable pedal module, the first cover part having a first end that is rotatably coupled to the vehicle; and
a second cover part that is disposed in the inner accommodation space of the first cover part and has an end that is rotatably coupled to the vehicle, the second cover part being configured to (i) protrude outward from the inner accommodation space based on the first cover part rotating about the first end of the first cover part and (ii) protrude outward relative to the foldable pedal module based on the second cover part rotating together with the first cover part.

3. The foldable partition apparatus of claim 2, wherein the actuator is connected to the first cover part and configured to rotate the first cover part about the first end of the first cover part.

4. The foldable partition apparatus of claim 3, wherein the actuator comprises a rod that extends in an axial direction, and
wherein the first cover part comprises a first cover comprising:
a first side wall including an actuator coupling part coupled to the actuator in the axial direction, the actuator coupling part defining a rod hole coupled to the rod of the actuator;
a first peripheral wall disposed at an edge of the first side wall; and
a second side wall that has a fan shape, wherein an edge of the second side wall is coupled to the first peripheral wall.

5. The foldable partition apparatus of claim 4, wherein the first peripheral wall comprises:
a first linear part that linearly extends between ends of the first side wall;
a first arc part that is connected to the first linear part and extends along an arc edge of the first side wall; and
a first peripheral part that is spaced apart from the actuator coupling part and surrounds the actuator coupling part.

6. The foldable partition apparatus of claim 5, wherein the first arc part has (i) a first end portion connected to the first linear part and (ii) a second end portion disposed away from the first linear part, and
wherein the first arc part comprises a first stopper that protrudes inward from an inner surface of the first arc part and is disposed at the second end portion of the first arc part.

7. The foldable partition apparatus of claim 5, wherein the first peripheral part comprises a folding stopper that protrudes outward from an outer surface of the first peripheral part, the folding stopper being configured to contact a bottom surface of a footrest panel of the foldable pedal module based on the side cover being in a folded state.

8. The foldable partition apparatus of claim 6, wherein the second cover part comprises:
a pair of third side walls that have a fan shape and face each other, wherein a size of each of the pair of third side walls is less than a size of the first side wall, and the pair of third side walls define insertion holes that receive the actuator coupling part; and
a second peripheral wall disposed at edges of the pair of third side walls.

9. The foldable partition apparatus of claim 8, wherein the second peripheral wall comprises:
a second linear part that linearly extend between ends of the pair of third side walls; and
a second arc part that is connected to the second linear part and extends along an arc edge of the pair of third side walls.

10. The foldable partition apparatus of claim 9, wherein the second arc part has an end portion connected to the second linear part, and
wherein the second arc part comprises a second stopper that is disposed at the end portion of the second arc part and protrudes outward from an outer surface of the second arc part, the second stopper being configured to interfere with the first stopper.

11. A vehicle, comprising:
a foldable pedal module comprising (i) a footrest panel and (ii) a brake pedal or an accelerator pedal, the foldable pedal module being configured to be folded and unfolded relative to the footrest panel; and
a side cover disposed at a side of the foldable pedal module and configured to protrude outward relative to the footrest panel based on the foldable pedal module being unfolded,
wherein the foldable pedal module further comprises an actuator configured to fold and unfold (i) the brake pedal or the accelerator pedal and (ii) the side cover.

12. The vehicle of claim 11, wherein the side cover comprises:
a first cover part that defines an inner accommodation space therein and is configured to protrude outward relative to the foldable pedal module, the first cover part having a first end rotatably coupled to the footrest panel; and
a second cover part that is disposed in the inner accommodation space of the first cover part and has an end that is rotatably coupled to the vehicle, the second cover part being configured to (i) protrude outward from the inner accommodation space based on the first cover part rotating about the first end of the first cover part and (ii) protrude outward relative to the foldable pedal module based on the second cover part rotating together with the first cover part.

13. The vehicle of claim 12, wherein the actuator comprises:
a motor comprising a rotating shaft;
a first gear disposed at the rotating shaft;
a second gear engaged with the first gear;
a link bar connected to a center of the second gear and configured to rotate based on rotation of the second gear;
a support member connected to the link bar, the support member comprising a driven rotor configured to reciprocally move based on rotation of the link bar;
a pedal effort generation module that includes a cam profile and is configured to fold and unfold the brake pedal or the accelerator pedal based on a reciprocal movement of the driven rotor;
a third gear disposed at an axis of the second gear and configured to rotate based on rotation of the second gear; and
a fourth gear connected to the first cover part and engaged with the third gear.

14. The vehicle of claim 13, wherein the actuator further comprises a rod that extends in an axial direction, and
wherein the first cover part comprises a first cover comprising:
a first side wall including an actuator coupling part coupled to the actuator in the axial direction, the actuator coupling part defining a rod hole coupled to the rod of the actuator;
a first peripheral wall disposed at an edge of the first side wall; and
a second side wall that has a fan shape, wherein an edge of the second side wall is coupled to the first peripheral wall.

15. The vehicle of claim 14, wherein the first peripheral wall comprises:
a first linear part that linearly extends between ends of the first side wall;
a first arc part that is connected to the first linear part and extends along an arc edge of the first side wall; and
a first peripheral part that is spaced apart from the actuator coupling part and surrounds the actuator coupling part.

16. The vehicle of claim 15, wherein the first arc part has (i) a first end portion connected to the first linear part and (ii) a second end portion disposed away from the first linear part, and
wherein the first arc part comprises a first stopper that protrudes inward from an inner surface of the first arc part and is disposed at the second end portion of the first arc part.

17. The vehicle of claim 16, wherein the first peripheral part comprises a folding stopper that protrudes outward from an outer surface of the first peripheral part, the folding stopper being configured to contact a bottom surface of the footrest panel based on the side cover being in a folded state.

18. The vehicle of claim 14, wherein the second cover part comprises:
a pair of third side walls that have a fan shape and face each other, wherein a size of each of the pair of third side walls is less than a size of the first side wall, and the pair of third side walls define insertion holes that receive the actuator coupling part; and
a second peripheral wall disposed at edges of the pair of third side walls.

19. The vehicle of claim 18, wherein the second peripheral wall comprises:
a second linear part that linearly extend between ends of the pair of third side walls; and
a second arc part that is connected to the second linear part and extends along an arc edge of the pair of third side walls.

20. The vehicle of claim 19, wherein the second arc part has an end portion connected to the second linear part, and
wherein the second arc part comprises a second stopper that is disposed at the end portion of the second arc part and protrudes outward from an outer surface of the second arc part, the second stopper being configured to interfere with the first stopper.
